(19) United States
(12) Patent Application Publication
(10) Pub. No.: US 2025/0321872 A1
(43) Pub. Date: Oct. 16, 2025

(54) SYSTEM FRAMEWORK FOR AUTOMATION TESTING OF SMART BED SYSTEM COMPONENTS

(71) Applicant: Sleep Number Corporation, Minneapolis, MN (US)

(72) Inventors: Madhu Yallampalli, Tracy, CA (US); Dino Hozic, Sarajevo (BA); Nedim Liscia, Sarajevo (BA)

(21) Appl. No.: 19/171,849

(22) Filed: Apr. 7, 2025

Related U.S. Application Data
(60) Provisional application No. 63/633,252, filed on Apr. 12, 2024.

(51) Int. Cl. G06F 11/3668; G06F 8/65; G06F 11/34

(52) U.S. Cl. CPC G06F 11/3688; G06F 8/65; G06F 11/3457

(57) ABSTRACT

An interface communicates with a smart bed remote control. A front-end system provides a graphical user interface (GUI) for receiving user input indicating one or more test actions to perform with the smart bed remote control, wherein the GUI presents a visual display of the smart bed remote control and user-interactable options that represent physical selectable controls on the smart bed remote control. A back-end system configured to provide communication between the front-end system and the smart bed remote control via the interface.

### CROSS-REFERENCE TO RELATED APPLICATION

This application claims benefit of U.S. Provisional Application No. 63/633,252, filed on Apr. 12, 2024. The disclosure of the prior application is hereby incorporated by reference in its entirety.

### TECHNICAL FIELD

The present document relates to computer-implemented automation testing frameworks and technology for physical components, such as bed components including remotes, controllers, sensors, and/or pumps.

### BACKGROUND

In general, a bed is a piece of furniture used as a location to sleep or relax. Many modern beds include a soft mattress on a bed frame. The mattress may include springs, foam material, and/or an air chamber to support the weight of one or more occupants.

Some bed systems can have features that are controllable by control elements, such as remote controls. A remote control can include selectable options, such as physical buttons and/or graphical user interface (GUI) visual elements, that can be selected by one or more occupants of a bed system to cause one or more actions to be performed at the bed system.

### SUMMARY

This document generally describes a computer-implemented framework and architecture for automation testing of physical components, such as bed components. The physical components can include but are not limited to remote controls, controllers, sensors, and/or pumps. The disclosed technology provides techniques for relevant users to perform automation testing of the physical component, regardless of a location of the user relative the physical component being tested. Both functional as well as visual automation testing can be performed using the disclosed techniques. The disclosed technology can, for example, provide remote simulation of human-machine interactions at the physical component, collect and aggregate results from such simulated interactions, and then output the aggregated results in a web interface or other graphical user interface (GUI) at a user device of the user conducting the automation testing of the physical component. The testing results can be used by the user to improve functionality and/or visual features of the physical component before the physical component is released or otherwise made available to end-consumers.

Accordingly, this document describes a framework that may include an interface for establishing a connection to the physical component to be tested, middleware or a back-end system for communicating through the interface with the physical component and performing automation testing and analysis of the physical component, a web interface or other GUI for receiving and performing test actions on the physical component, and a front-end system that provides the interface to the relevant user performing the testing. The disclosed framework can also provide a wrapper including tools for integrating and providing various testing capabilities to the relevant user.

In some aspects, the techniques described herein relate to a system for testing a smart bed remote control, the system including: an interface for communicating with a smart bed remote control; a front-end system configured to provide a graphical user interface (GUI) for receiving user input indicating one or more test actions to perform with the smart bed remote control, wherein the GUI presents a visual display of the smart bed remote control and user-interactable options that represent physical selectable controls on the smart bed remote control; and a back-end system configured to provide communication between the front-end system and the smart bed remote control via the interface, wherein the back-end system is further configured to: receive, from the front-end system, the user input indicating the one or more test actions to perform with the smart bed remote control; generate, based on the user input, test instructions for the smart bed remote control; transmit, via the interface, the test instructions to the smart bed remote control, wherein transmitting the test instructions causes the one or more test actions to be executed by the smart bed remote control; receive, via the interface, data indicating results from executing the test instructions by the smart bed remote control, wherein the results include at least one of (i) functional results based on executing the test instructions to test functionality of the physical selectable controls on the smart bed remote control or (ii) visual results from executing the test instructions to test visual output presented at a user interface display of the smart bed remote control in response to executing the test instructions; generate, in real-time and based on the received data, output indicating the results; and return, to the front-end system, the generated output for presentation in the GUI.

In some aspects, the techniques described herein relate to a system, wherein the interface for communicating with the smart bed remote control includes a physical connection to the smart bed remote control using a debug probe and a serial adapter.

In some aspects, the techniques described herein relate to a system, wherein the debug probe is configured to provide (i) direct memory access, (ii) framebuffer dumps, and (iii) retrieval of on-screen images of the visual output presented at the user interface display of the smart bed remote control between the smart bed remote control and the back-end system.

In some aspects, the techniques described herein relate to a system, wherein the back-end system is configured to transmit firmware updates to the smart bed remote control using the debug probe of the interface to cause firmware of the smart bed remote control to be automatically updated according to the firmware updates.

In some aspects, the techniques described herein relate to a system, wherein the serial adapter is configured to enable access to a serial console of the smart bed remote control by the back-end system to (i) retrieve bed system component state data and (ii) pass tokens for simulating the one or more test actions.

In some aspects, the techniques described herein relate to a system, wherein the one or more test actions include simulation of pressing one or more buttons on the smart bed remote control.

In some aspects, the techniques described herein relate to a system, wherein the GUI is a web interface that is configured to be launched in a web application at a user computing device, the user computing device being configured to receive the user input indicating the one or more test actions to perform with the smart bed remote control.

In some aspects, the techniques described herein relate to a system, wherein the back-end system is configured to be implemented on a RASBERRY PI.

In some aspects, the techniques described herein relate to a system, wherein the back-end system includes four ARM64 cores and 4 GB of RAM.

In some aspects, the techniques described herein relate to a system, wherein the back-end system is further configured to provide and control a power supply to the smart bed remote control via the interface.

In some aspects, the techniques described herein relate to a system, wherein the back-end system is further configured to provide testing of power capabilities of the smart bed remote control based on providing and controlling the power supply to the smart bed remote control via the interface.

In some aspects, the techniques described herein relate to a system, wherein the back-end system includes a PYTHON framework.

In some aspects, the techniques described herein relate to a system, wherein the back-end system includes WEBSOCKETS protocol support.

In some aspects, the techniques described herein relate to a system, wherein the front-end system is configured to transmit the GUI for presentation at a user computing device that is remote from the smart bed remote control.

In some aspects, the techniques described herein relate to a system, further including a data store configured to store at least one of: the one or more test actions, the test instructions, the data indicating results from executing the test instructions, or the output indicating the results.

In some aspects, the techniques described herein relate to a system, further including a logging software subsystem configured to: communicate with the smart bed remote control via the interface; retrieve, from the smart bed remote control, logs resulting from testing the smart bed remote control according to the one or more test actions; attach the retrieved logs to test run data that correspond to each of the one or more test actions; and store the test run data with the attached logs in a data store for subsequent test evaluation of the smart bed remote control.

In some aspects, the techniques described herein relate to a system, wherein the smart bed remote control is configured to provide state information, via the interface to the back-end system, during execution of the one or more test actions, wherein the back-end system is further configured to generate the output indicating the results based on the state information.

In some aspects, the techniques described herein relate to a system, wherein the system further includes an automation test framework for acceptance testing and acceptance test-driven development that is configured to wrap around the interface, the front-end system, and the back-end system and provide tools for automation testing of the smart bed remote control.

In some aspects, the techniques described herein relate to a method for automation testing of a bed system component, the method including: receiving, by a back-end system from a front-end system, user input indicating one or more test actions to perform with a bed system component, wherein the back-end system is configured to provide communication between the front-end system and the bed system component via an interface, wherein the front-end system is configured to provide a graphical user interface (GUI) for receiving the user input indicating the one or more test actions to perform with the bed system component, wherein the GUI presents a visual display of the bed system component and user-interactable options that represent physical selectable controls on the bed system component; generating, by the back-end system and based on the user input, test instructions for the bed system component; transmitting, by the back-end system via the interface, the test instructions to the bed system component, wherein transmitting the test instructions causes the one or more test actions to be executed by the bed system component; receiving, by the back-end system via the interface from the bed system component, data indicating results from executing the test instructions by the bed system component, wherein the results include at least one of (i) functional results based on executing the test instructions to test functionality of the physical selectable controls on the bed system component or (ii) visual results from executing the test instructions to test visual output presented at a user interface display of the bed system component in response to executing the test instructions; generating, by the back-end system based on the received data, output indicating the results; and transmitting, by the back-end system to the front-end system, the generated output for presentation in the GUI.

In some aspects, the techniques described herein relate to a test system for automation testing of a physical component, the system including: an interface for communicating with the physical component; and a computing system in communication with the physical component via the interface, wherein the computing system is configured to: provide a graphical user interface (GUI) for receiving user input indicating one or more test actions to perform with the physical component; receive the user input indicating the one or more test actions to perform with the physical component; generate, based on the user input, test instructions for the physical component; transmit, via the interface, the test instructions to the physical component, wherein transmitting the test instructions causes the one or more test actions to be executed by the physical component; receive, via the interface, data indicating results from executing the test instructions at the physical component, wherein the results include at least one of (i) functional results based on executing the test instructions to test functionality of physical selectable controls on the physical component or (ii) visual results from executing the test instructions to test visual output presented at a user interface display of the physical component in response to executing the test instructions; generate, in real-time and based on the received data, output indicating the results; and return the generated output for presentation in the GUI.

In some aspects, the techniques described herein relate to a test system, wherein the computing system includes a front-end system and a back-end system.

In some aspects, the techniques described herein relate to a test system, wherein the front-end system is configured to provide for the receiving user input indicating one or more test actions to perform with the physical component.

In some aspects, the techniques described herein relate to a test system, wherein the back-end system is configured to provide for the receiving, the generating, and the returning.

In some aspects, the techniques described herein relate to a test system, wherein the physical component is a smart bed system component.

In some aspects, the techniques described herein relate to a test system, wherein the physical component is a remote control for a bed system.

In some aspects, the techniques described herein relate to a test system, wherein the physical component is a sensor of a smart bed system, the sensor being at least one of the group consisting of a temperature sensor, a humidity sensor, a pressure sensor, an audio sensor, and a load cell.

In some aspects, the techniques described herein relate to a test system, wherein the GUI presents a visual display of the physical component and user-interactable options that represent physical selectable controls on the physical component.

In some aspects, the techniques described herein relate to a test system, the system further including a logging software subsystem configured to: communicate with the physical component via the interface; retrieve, from the physical component, logs resulting from testing the physical component according to the one or more test actions; attach the retrieved logs to test run data that correspond to each of the one or more test actions; and store the test run data with the attached logs in a data store for subsequent test evaluation of the physical component.

In some aspects, the techniques described herein relate to an automation test framework for real-time testing of a physical component that is remote from a testing user interface (UI), the testing UI configured to receive testing instructions, provide the testing instructions to the physical component, and return results from execution of the testing instructions by the physical component.

In some aspects, the techniques described herein relate to a test system for testing a sleep system component, the system including: a computer system configured to: provide a graphical user interface (GUI) for receiving user input indicating one or more test actions to perform a sleep system component, wherein the GUI presents a visual display of the sleep system component; receive the user input indicating the one or more test actions to perform with the sleep system component; generate, based on the user input, test instructions for the sleep system component; transmit the test instructions to the sleep system component for execution; receive data indicating results from executing the test instructions at the sleep system component; and return the data indicating the results.

In some aspects, the techniques described herein relate to a test system, wherein the sleep system component is a remote control for a bed system.

In some aspects, the techniques described herein relate to a test system, wherein the GUI presents a visual representation of a user interface of a remote control.

In some aspects, the techniques described herein relate to a test system, wherein the GUI presents user-selectable options that correspond to physical selectable controls on the sleep system component.

In some aspects, the techniques described herein relate to a test system, wherein the results include functional results based on executing the test instructions to test functionality of physical selectable controls of the sleep system component in response to executing the test instructions.

In some aspects, the techniques described herein relate to a test system, wherein the results include visual results from executing the test instructions to test visual output presented at a user interface display of the sleep system component in response to executing the test instructions.

In some aspects, the techniques described herein relate to a test system, wherein returning the data includes: generating, based on the received data, output indicating the results; and returning the generated output for presentation in the GUI.

The devices, system, and techniques described herein may provide one or more of the following advantages. For example, the disclosed techniques provide a custom testing environment for streamlined and resource-efficient automation testing of various types of physical components. Sometimes, a physical remote can be tested using glue scripts for interfacing with features of the remote. Test results may be asserted through means of binary diff's on content displayed on a screen of the remote, by comparing known screenshots from the remote with those acquired during a test of the remote functionality. However, comparing screenshot content may indicate whether data presented at the remote matches or does not match what is expected for the remote. In other words, the screenshot content cannot be analyzed further to glean insight into whether the remote is functioning properly. Furthermore, whenever the UI is updated for the remote, new screenshots need to be captured and then used in the testing, which increases usage of available resources (e.g., compute power, processing, human, labor) before the remote can even be tested. The disclosed techniques, on the other hand, provide streamlined and efficient automation testing of the remote, and other physical components, without having to rely on screenshot content comparisons, glue scripts, or updating testing content whenever changes/modifications are made to the physical component. The disclosed techniques can be easily integrated into existing or new testing frameworks and applied to perform automation testing of various different types of physical components, without having to rewrite testing scripts and/or use cases. Therefore, the disclosed techniques may efficiently utilize available compute resources to streamline automation testing of the physical components and allow for the compute resources to be allocated to other processing-intensive techniques.

Similarly, the disclosed techniques provide for scalability of automation testing. The disclosed techniques can be easily and efficiently applied to perform automation testing of various different types of components. The disclosed techniques may also be easily adapted to provide automation testing of physical components that undergo versioning updates, firmware updates, and/or software updates. As a result, compute and labor/human resources may not be expended to update automation testing scripts and/or use cases—the disclosed automation testing framework can simply be applied to any physical component and/or any version of the physical component.

Furthermore, the disclosed techniques provide efficiency in automation testing by allowing relevant users to test physical components regardless of where they are physically located relative the physical components. As an illustrative example, the user can be a service technician. A bed customer can call the service technician about having an issue with a remote for their smart bed. The service technician can test the remote remotely using the automation testing framework described herein. As a result, the service technician can diagnose an issue with the remote without having to be physically located in a home of the customer having the issue with the remote for their smart bed.

The details of one or more implementations are set forth in the accompanying drawings and the description below. Other features, aspects and potential advantages will be apparent from the accompanying description and figures.

### DESCRIPTION OF DRAWINGS

FIGS. 1A-B are conceptual diagrams of an automation testing framework for testing a smart bed system component.

FIG. 2 is a system diagram of system components that can perform the disclosed techniques.

FIG. 3 is a flowchart of a process for automation testing of a physical component, such as a smart bed system component.

FIG. 4 is a swimlane diagram of a process for automation testing of a physical component, such as a smart bed system component.

FIG. 5 shows an example air bed system.

FIG. 6 is a block diagram of an example of various components of an air bed system, such as the air bed system of FIG. 5.

FIG. 7A is a block diagram of an example of a sensory array that can be used in a data processing system associated with a bed.

FIG. 7B is a block diagram of an example of a control array that can be used in a data processing system associated with a bed.

FIG. 8 is a schematic diagram that shows an example of a computing device and a mobile computing device.

Like reference symbols in the various drawings indicate like elements.

### DETAILED DESCRIPTION

This document generally describes a system architecture and techniques for automation testing of physical components, including but not limited to bed components such as remote controls, controllers, sensors (e.g., audio, temperature, humidity, pressure, load cells), and/or pumps. In particular, a web interface or other GUI can be provided to a relevant user testing the physical component. The interface can provide functionality of the physical component being tested, such as access to buttons and a screen of a physical remote control. Automation testing can be performed through the interface, and thus remote from an actual location of the physical component being tested. Tools that may be used in automation testing of a web application, for example, can be implemented in the interface described throughout this disclosure in order to make it easy for the user, and any other relevant user, to efficiently perform automation testing of the physical remote control.

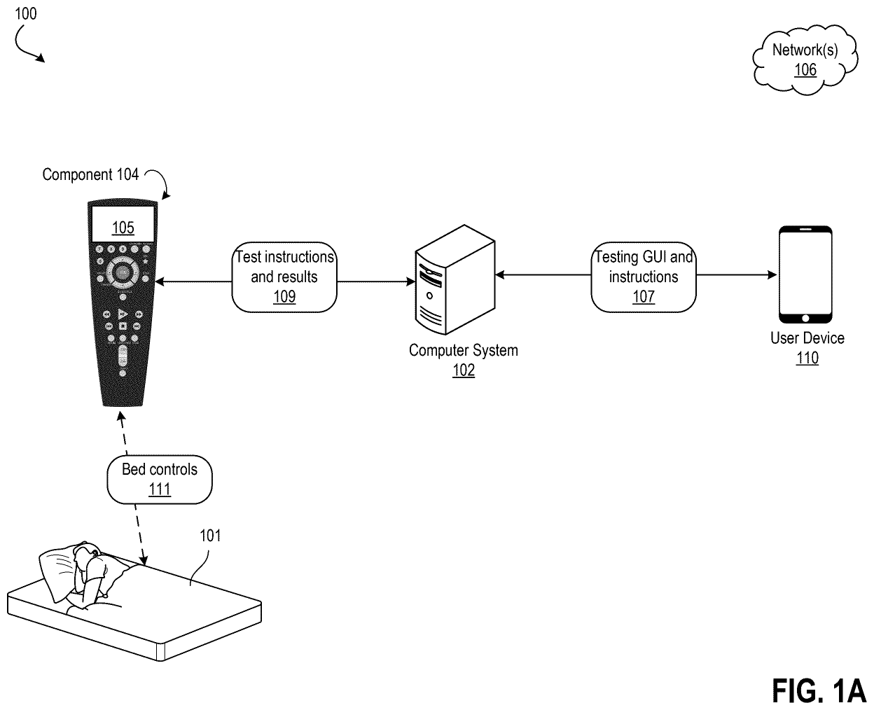

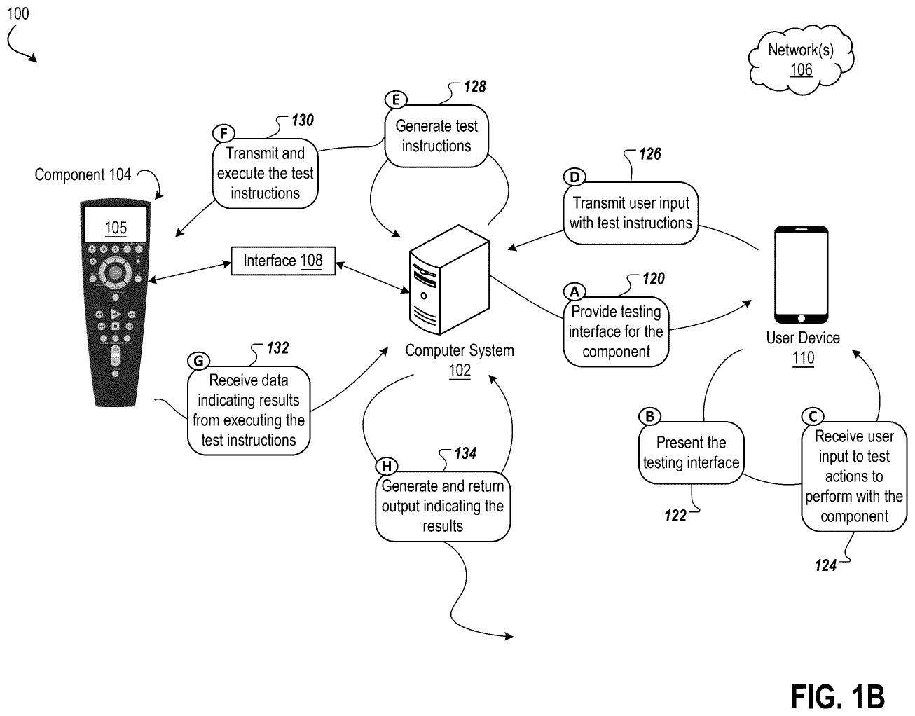

FIGS. 1A-B are conceptual diagrams of an automation testing framework 100 for testing a smart bed system component. Referring to FIG. 1A, a computer system 102 can communicate (e.g., wired and/or wireless) with a physical component 104 and a user device 110. Such communication can occur through network(s) 106 such as a local network, a wide area network, the Internet, etc. The computer system 102 can be any appropriate type of computing system, server, computing device, network of computing systems or devices, and/or cloud-based system. The user device 110 can be any appropriate type of computing device or system that is to be tested, including but not limited to a mobile phone, smartphone, laptop, tablet, and/or computer.

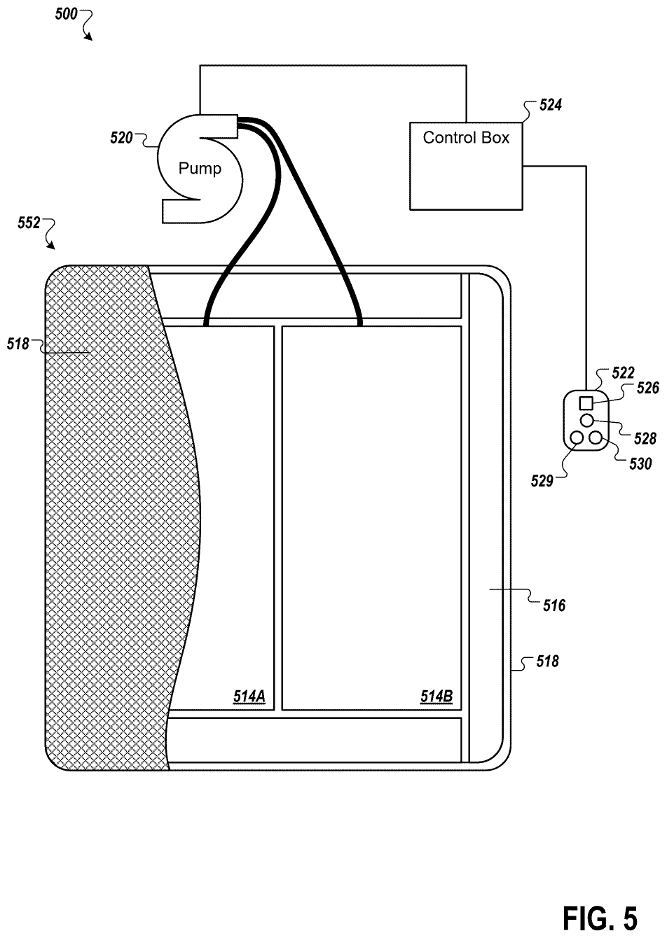

The physical component 104 can be one or more components of a bed system. In the illustrative example of at least FIG. 1A, the physical component 104 is a remote control for a bed system 101. The physical component 104 also includes a display screen 105. The display screen 105 can output information as a result of various controls (e.g., buttons) being selected on the physical component 104. In some implementations, the display screen 105 can be a touch screen and can also receive user input to control components of the bed system 101 via the remote. The bed system 101 can be a smart bed. Refer to FIGS. 5-7 for further discussion about the bed system 101.

In some implementations, as shown in FIG. 1A, the computer system 102 is separate and/or remote from at least one of the bed system 101, the physical component 104, and/or the user device 110. In some implementations, the computer system 102 can be part of the bed system 101, such as a controller of the bed system 101. Sometimes, the computer system 102 and the user device 110 can be part of a same computing system.

As shown in FIG. 1A, testing GUIs and/or instructions data can be transmitted between the computer system 102 and the user device 110 (block 107). For example, GUIs can be generated by the computer system 102 and presented at the user device 110 to provide a testing framework for the physical component 104. A relevant user at the user device 110 can interact with controls, graphical elements, and other features presented in the GUI(s) to generate instructions for testing various functionality and/or visual aspects of the physical component 104. These instructions are transmitted back to the computer system 102.

Testing instructions and/or testing results can also be transmitted between the computer system 102 and the physical component 104 (block 109). The instructions that are provided to the computer system 102 by the user device 110 can be transmitted to the physical component 104 in block 109. The instructions can be executed at the physical component 104. Results from executing the instructions at the physical component 104 are then transmitted back to the computer system 102. The computer system 102 can process the results and/or provide the results back to the user device 110 for presentation in the GUI(s).

Bed controls data can also be transmitted between the physical component 104 and the bed system 101 (block 111). The bed controls data can indicate what physical button(s) was pressed as part of the testing (e.g., pressing one or more buttons to increase or decrease pressure in an air chamber of a mattress, pressing one or more buttons to adjust a tilt of a foundation). In some implementations, the bed controls data can be transmitted in block 111 at a different time than when blocks 107 and/or 109 are performed. For example, the bed controls data can be transmitted during runtime use of the physical component 104 to control the bed system 101 whereas the testing instructions and testing results can be transmitted during testing of the physical component 104 before the physical component 104 is used during runtime. In some implementations, the bed controls data can be transmitted between the physical component 104 and the bed system 101 (block 111) in response to executing the test instructions at the physical component 104 by the computer system 102 (block 109).

Referring to FIG. 1B, operations of the system 100 are shown in more detail. The computer system 102 can provide a testing interface for the physical component 104 to the user device 110 (block A, 120). The testing interface can include the GUIs described herein.

The user device 110 presents the testing interface to the relevant user (block B, 122). The user device may also receive user input to test one or more actions to perform with the physical component 104 (block C, 124). As an illustrative example, the physical component 104 can be the remote control for the smart bed system 101 described in FIG. 1A. The user input can include selection of visual representations of physical controls (e.g., buttons) on the remote that are presented in the GUI at the user device 110. The computer system 102 can translate the user input indicating the selection of the visual representations of the physical controls into instructions that, when executed by the remote, cause the remote to generate information indicating what happens with the remote in response to selecting the physical controls on the remote.

Accordingly, the user input with the test instructions can be transmitted by the user device 110 to the computer system 102 (block D, 126). Based on the user input, the computer system 102 can generate test instructions for execution by the physical component 104 (block E, 128).

The computer system 102 then transmits and executes the test instructions at the physical component 104 (block F, 130). In some implementations, upon receiving the test instructions, the physical component 104 can execute the instructions. In some implementations, the computer system 102 can execute the instructions at the physical component 104. For example, the physical component 104 can be put into a test mode, which can be distinct from a runtime mode. During the test mode, one or more debugging features can be turned on or activated at the physical component 104 while other features of the physical component 104 may be turned off or deactivated. As an illustrative example, in the test mode, the debugging features can include simulating virtual button or key presses at the physical component 104 according to the test instructions while disabling actual physical keys or buttons of the physical component 104. On the other hand, during the runtime mode, the actual physical keys or buttons of the physical component 104 may be activated but the debugging features of virtual simulation may be deactivated.

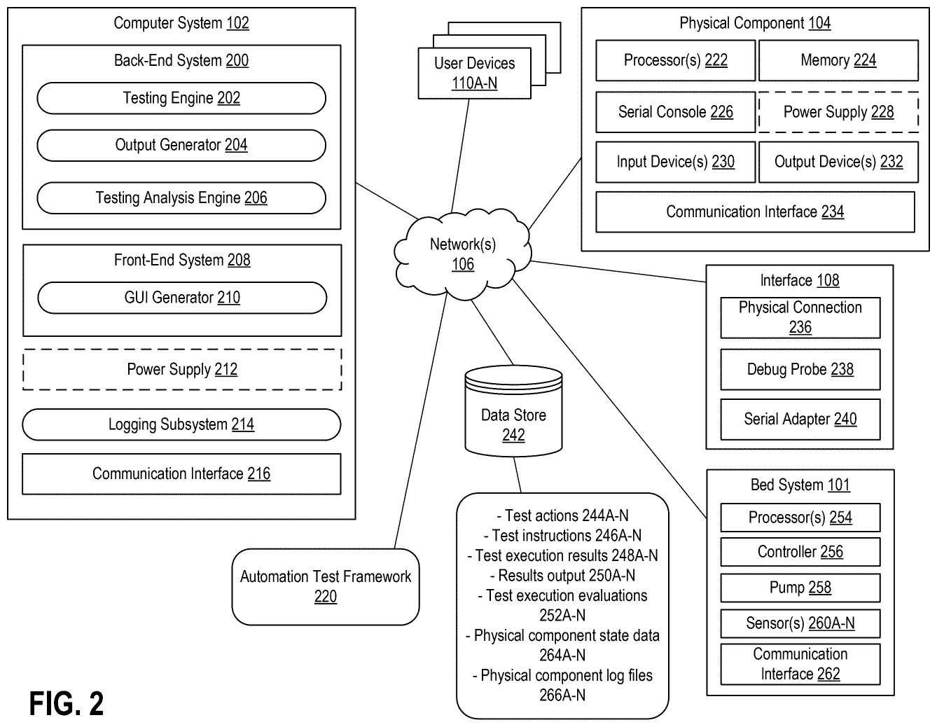

Communication between the computer system 102 and the physical component 104 can be established via an interface 108. The interface 108 can be a wireless interface, such as an API. The interface 108 can additionally or alternatively include a wired communication. Refer to FIG. 2 for further discussion about the interface 108.

The computer system 102 can receive data indicating results from executing the test instructions at the physical component 104 (block G, 132). The data can be transmitted from the physical component 104 to the computer system 102 via the interface 108.

Based on the received data the computer system 102 can generate and return output indicating the test results (block H, 134). Returning the output can include transmitting the output to the user device 110 for presentation in the testing interface or the GUI(s) described herein. Returning the output can include storing the output in a data store.

FIG. 2 is a system diagram of system components that can perform the disclosed techniques. The computer system 102, user devices 110A-N, physical component 104, interface 108, and bed system 101 can communicate via the network(s) 106. A data store 242 may also communicate with any of these system components via the network(s) 106. Software such as an automation test framework 220 may additionally or alternatively communicate with the system components via the network(s) 106.

The computer system 102 can include a back-end system 200, a front-end system 208, an optional power supply 212, a logging subsystem 214, and a communication interface 216. The back-end system 200 generally includes servers, applications, and/or databases that work to provide/deliver information to relevant users. The front-end system 208 generally refers to part of an information system that can be accessed and interacted with by users such that the users can receive and utilize back-end capabilities of the back-end system 200. The front-end system 208 can, for example, provide various user interfaces for the users to interact with information that is generated and provided using the disclosed techniques.

The back-end system 200 can include software such as a testing engine 202, an output generator 204, and a testing analysis engine 206. The back-end system 200 can be configured to generate testing instructions for testing the physical component 104 and assess results from executing the testing instructions at the physical component 104. In some implementations, the back-end system 200 can be a middle layer, or middleware, of the computer system 102. The back-end system 200 can provide a link/communication between the front-end system 208 (or more particular GUIs provided to the relevant users at the user devices 110A-N via the front-end system 208) and the physical component 104. As an illustrative example, the back-end system 200 provides for control selections at the GUI(s) presented at the user device 110 to be received at the front-end system 208 and commanded to the physical component 104 itself, while content outputted at the physical component 104 (e.g., presented in a display screen at the physical component 104) are screen-captured in real-time or near real-time and provided back to the GUI at the user device 110 via the front-end system 208. As another illustrative example, the back-end system 200 can implement a framework (e.g., a PYTHON framework, such as FASTAPI) that is: fully featured (e.g., provides WEBSOCKETS support), fast and efficient to run (e.g., lightweight enough to be deployed on a RASBERRY PI), fast to program/code, intuitive and easy for editor support, robust and reliable to provide accurate rest results, and standards-based (e.g., best practices and standards are followed throughout implementation).

Still referring to the back-end system 200, the testing engine 202 can receive actions to test from the user device 110. The engine 202 can generate testing instructions that, when transmitted to and executed by the physical component 104, cause the physical component 104 to perform the test actions. As an illustrative example, the testing engine 202 can instruct the physical component 104 about what buttons or other controls on the physical component 104 should be triggered based on the user input received from the user device 110 and transmitted to the front-end system 208. The testing engine 202 can also receive or retrieve test results from the physical component 104 in response to executing the testing instructions. For example, the testing engine 202 can receive state and/or log files from a serial console 226 of the physical component 104 via one or more components of the interface 108.

The output generator 204 can be configured to generate output based on the results from executing the testing instructions at the physical component 104. For example, the generator 204 can receive screenshots or other screen captures of information that is presented on a display screen of the physical component 104 in response to executing the testing instructions. The generator 204 can process the received screenshots for presentation in the GUI at the user device 110. The generator 204 can, in some implementations, transmit the output to the front-end system 208. The front-end system 208 can then update the GUI presented at the user device 110 with the output. Such updates can be performed in real-time or near real-time.

The testing analysis engine 206 can be configured to assess the results from executing the testing instructions at the physical component. Analysis results generated by the engine 206 can also be provided to the output generator 204 and/or the front-end system 208 to then be presented to the user in the GUI at the user device 110.

The front-end system 208 can include software such as a GUI generator 210. The front-end system 208 can be configured to provide information to the user at the user device 110 for interacting with and testing the physical component 104. For example, the GUI generator 210 can be configured to generate and provide a web application, interface, or other type of GUI(s) described herein to the user devices 110A-N. The GUI can create and provide a virtual-based (e.g., web-based) version of the physical component 104. If the physical component 104 is a remote control, for example, the GUI can provide a web-based version of the remote control. This enables easy and efficient automation while providing the user with ways in which to access the physical component 104 and test the physical component 104 from virtually anywhere. This can enable remote testing, improvement, updates, and/or work on the physical component 104. The front-end system 208 can include a front-end framework and an automation framework. These frameworks can be custom-designed for particular testing environments. In some implementations, the front-end system 208 can employ opensource frameworks or other known frameworks. The GUI generator 210 can be configured to generate the virtual version of the physical component 104 using one or more custom and/or known frameworks.

The optional power supply 212 can be configured to provide power to the physical component 104. As an illustrative example, the power supply 212 can be a USB Type-C 15 W power supply. One or more other types of power supplies are also possible, including but not limited to battery-operated power supplies, solar panels, induction chargers, and/or wireless chargers. The back-end system 200 can, in some implementations, program the power supply 212 to provide power to the physical component 104. In yet some implementations, the back-end system 200 can program the power supply 212 according to the testing instructions to test power usage/consumption of the physical component 104. Since the physical component 104 can be powered directly by the power supply 212 of the computer system 102, the physical component 104's power consumption can be toggled directly through software provided at the back-end system 200, which further enables power profiling efforts and testing to be performed. Moreover, this configuration may eliminate a need for physical interaction with any one or more parts of the physical component 104, which allows for remote testing of the physical component 104 as described herein.

The logging subsystem 214 can be software that is part of the computer system 102. In some implementations, the logging subsystem 214 can be separate from the computer system 102. The logging subsystem 214 can be configured to retrieve log files and/or state information/data from the physical component 104 when/once the testing actions are executed at the physical component 104. Running testing actions, and just knowing if the testing actions passed or failed, may be of limited use since it does not provide data about the state in which the physical component 104 was in at the time of testing. This may also make reproduction of a bug or other glitch in the physical component 104 virtually impossible. Therefore, the subsystem 214 can be configured to automatically acquire logs that are generated by the physical component 104 before, during, and/or after executing the testing actions, attach/append/associate the logs with the testing actions, and store the associated logs and testing actions, such as in the data store 242. The logs therefore provide additional information/data about the physical component 104, which can be used by the testing analysis engine 206 of the back-end system 200 to assess functionality and/or visual information associated with the physical component 104. Accordingly, the logs can be used for subsequent, in-depth evaluation of the physical component 104 during automation testing.

The communication interface 216 can provide communication between and amongst components of the computer system 102 and other system components described in FIG. 2.

In some implementations, the computer system 102 can be a RASPBERRY PI. In some implementations, one or more of the back-end system 200 and the front-end system 208 can be a RASPBERRY PI. As a RASPBERRY PI, for example, the computer system 102 can include necessary hardware peripherals for interfacing with the physical component 104 in test. The computer system 102 can include, as an illustrative example, one or more (e.g., four) ARM64 cores coupled with 4 GB of RAM, thereby providing sufficient computing power for efficiently running the operations and processing described herein. This configuration of the computer system 102 may also reduce overall cost of testing one or more physical components. Moreover, this configuration of the computer system 102 provides additional flexibility in automation testing tasks.

Still referring to FIG. 2, the physical component 104 can include processor(s) 222, memory 224, a serial console 226, an optional power supply 228, input device(s) 230, output device(s) 232, and a communication interface 234. As described herein, the physical component 104 can be a remote control, which can communicate via the network(s) 106 with the bed system 101. The physical component 104 can also be one or more other components of the bed system 101, including but not limited to a controller, pump, temperature sensor, pressure sensor, load cell, humidity sensor, or other device or component of a smart bed system.

The processor(s) 222 can be configured to perform one or more operations at the physical component 104. For example, the processor(s) 222 can execute testing instructions that are provided by the computer system 102. As another example, the processor(s) 222 can execute bed control instructions during runtime use of the bed system 101. The memory 224 can be any type of memory storage device that is part of the physical component 104 and configured to store information and data about the physical component 104 and/or actions performed by/at the physical component 104.

The serial console 226 can be hardware that allows a connection for the computer system 102 to access a console of the physical component 104. For example, during and/or after executing test instructions at the physical component 104, the physical component 104 provides information/data on its state during the testing (such as log files) via the serial console 226 and over a serial adapter 240 of the interface 108 between the physical component 104 and the computer system 102. In some implementations, Serial Wire Debug (SWD) protocol can be used for transmitting the state information/data over the interface 108 between the physical component 104 and the computer system 102. The SWD protocol can use an ARM CPU standard bi-directional wire protocol, which can also be known as an ARM debug programmer. In some implementations, a Secure Shell (SSH) protocol may be used, which is a network communication protocol enabling the physical component 104 and the computer system 102 to communicate and share information/data. Various other protocols may also be used to transmit the state information/data between the physical component 104 and the computer system 102.

The optional power supply 228 can provide power to the physical component, such as a battery (e.g., internal, external). The power supply 228 can, in some implementations, include a wireless charger and/or an induction charger. In some implementations, testing instructions provided by the computer system 102 can be used to test the power supply 228. In some implementations, the power supply 228 can be programmed by the computer system 102 (which can depend on the testing results, in some implementations).

The input device(s) 230 can include any variety of components, controls, and/or buttons that may be selected by a user to control the bed system 101 via the physical component 104. For example, the input devices(s) 230 can include physical, selectable buttons. The input device(s) 230 can additionally or alternatively include a touch screen display, microphone, etc. Test instructions that are executed at the physical component 104 can be configured to test what happens when one or more of the input device(s) 230 are selected. The results from such testing can be identified in the state information/data and/or log files that are generated by the physical component 104, as described herein.

The output device(s) 232 can include any variety of components of the physical component 104 that may present information to the user. For example, the output device(s) 232 can include a touchscreen display or other type of display screen. The output device(s) 232 can present information to the user in response to user selection of one or more of the input device(s) 230 (e.g., selection of one or more buttons to control the bed system 101). Test instructions that are executed at the physical component 104 can cause information to be presented by the output device(s) 232. The information presented therein can be screenshotted or otherwise captured and maintained in the state information/data and/or log files that are generated by the physical component 104.

The communication interface 234 can provide communication between and amongst components of the physical component 104 and other system components described in FIG. 2.

The interface 108 can include a physical connection 236, a debug probe 238, and a serial adapter 240. As an illustrative example, the interface 108 can include a SEGGER J-LINK PLUS debug probe, a SEGGER J-LINK 10-pin need adapter, and an FTDI TTL-232R-3V3 cable. The interface 108 can provide the physical connection 236 between the computer system 102 and the physical component 104. For example, the interface 108 can provide the physical connection 236 using an ARM SWD debug probe 238 and/or UART-to-SB adapter (e.g., 3V3 voltage levels). The debug probe 238 can be a type of hardware that can be used for direct memory access of the physical component 104 by the computer system 102. For example, the debug probe 238 can allow for reading and writing registers and memory of the physical component 104. The debug probe 238 can be configured to look up a particular memory access and retrieve data associated with that memory access. The debug probe 238 can also be used for dumping framebuffers and retrieving on-screen images from the physical component 104 (e.g., visual output presented at a user interface display of the physical component 104). In some implementations, firmware updates can be performed over the interface 108, using the physical connection 236 and/or the debug probe 238. Accordingly, the firmware of the physical component 104 can be automatically updated according to the firmware updates. In some implementations, the firmware updates can be determined by the back-end system 200 in response to assessing results from testing one or more functional and/or visual aspects of the physical component 104. The debug probe 238 can connect to the physical component 104 via a standard debug port while connecting to the computer system 102 via an ETHERNET or USB port and cable.

The serial adapter 240 can be a type of hardware that enables access to the physical component 104's serial console 226. The serial adapter 240 can be a device that adds a serial port to the physical component 104. For example, the serial adapter 240 can plug into a USB power of the physical component 104 and contain one or more serial port sockets. The serial adapter 240 can provide a serial communication interface through which information or data transfers in and/or out of the physical component 104 to the computer system 102 sequentially, one bit at a time. The serial adapter 240 can then be used for retrieving state data of the physical component 104. The serial adapter 240 can also be used for passing tokens that may be required to simulate pressing or selecting particular controls on the physical component 104, such as buttons (e.g., input device(s) 230).

The debug probe 238 and the serial adapter 240 provide for simulation of interaction between a user and the physical component 104. Thus, buttons or other controls of the physical component 104 can be pressed while outputted visual content at the physical component 104 can be retrieved (then processed by the computer system 102 as part of automation testing described herein). Accordingly, communicating with the physical component 104 via the interface 108 enables interaction with the physical component 104 in a same way as a manual, human tester would interface with and use the physical component 104.

In some implementations, the interface 108 can be configured to physically connect to the physical component 104 via a battery compartment of the physical component 104 (e.g., the optional power supply 228 of the physical component 104). For example, connecting multiple cables to the physical component 104 can limit a testing setup's portability and stability, in addition to raising overall costs of automation testing. In order to allow for the physical component 104 to be tethered by one cable or physical connection (e.g., in testing and development stages), the interface 108 can be connecting to test points provided in the battery compartment of the physical component 104. With a 3D-printed part containing a PCB populated with compatible spring-loaded pogo-pins, interfacing with the physical component 104 via the interface 108 is possible without having to connect cables to PCB headers (which can be fragile) and/or alligator clips attaching to battery springs. Connecting the interface 108 with the physical component 104 via the battery compartment can provide for full access to the physical component 104's hardware in minimal time (e.g., less than 10 seconds) and also allow for rapid firmware updates to be implemented on many different devices, including the physical component 104.

The bed system 101 can include processor(s) 254, a controller 256, a pump 258, sensor(s) 260A-N, and a communication interface 262. As described herein, the bed system 101 can be a smart bed. The processor(s) 254 can be configured to perform operations at the bed system 101. Similarly, the controller 256 can be configured to execute instructions to control one or more components of the bed system 101. In some implementations, the processor(s) 254 can be part of the controller 256. Sometimes, the controller 256 can include the computer system 102. Sometimes, the controller 256 can be remote from the bed system 101. The controller 256 can perform operations such as adjusting a tilt, height, and/or incline of one or more portions of a foundation (e.g., frame) of the bed system 101. The controller 256 can perform operations such as adjusting a pressure level inside one or more air chambers of a mattress of the bed system 101. The controller 256 can perform operations such as adjusting a microclimate at a top surface of the mattress of the bed system 101 (e.g., activating a heating element, activating one or more fans or a thermal module of the bed system 101). One or more other operations can be performed by the controller 256, as described further in reference to FIGS. 5-7. In some implementations, the disclosed techniques for automation testing can be applied to test functionality of the controller 256.

The pump 258 can be configured to control fluid pressure in one or more air chambers of the mattress of the bed system 101. Refer to at least FIG. 5 for further discussion about the pump 258. Moreover, the disclosed techniques for automation testing can be applied to test functionality of the pump 258.

The sensor(s) 260A-N can include one or more different types of sensors integrated into the mattress, a foundation, the pump 258, the controller 256, and/or one or more other components of the bed system 101. In some implementations, the sensors(s) 260A-N may be remote from the bed system 101, including but not limited to wearable sensor devices, ambient environmental-sensing devices, home automation devices, mobile phones, smartphones, and/or other smart home devices. The sensors 260A-N can include temperature sensors, humidity sensors, pressure sensors, motion sensors, load cells, weight sensors, or other types of sensors described herein. Refer to FIGS. 5-7 for further discussion about the sensors 260A-N. Moreover, the disclosed techniques for automation testing can be applied to testing functionality of one or more of the sensors 260A-N.

The communication interface 262 can provide communication between and amongst components of the bed system 101 and other system components described in FIG. 2.

The automation test framework 220 can provide tools for performing various types of tests with the physical component 104. The framework 220 can be implemented via the GUI provided by the front-end system 208 to the user devices 110A-N. The framework 220 can provide for acceptance testing and acceptance test-driven development. The framework 220 can wrap around the interface 108, the back-end system 200, and the front-end system 208 in order to provide tools for automation testing of the physical component 104. In some implementations, the framework 220 provides real-time or near real-time testing of the physical component 104 that is remote from the testing GUI presented at the user device(s) 110. The framework 220 can be custom-designed and/or based on existing or other available frameworks.

The data store 242 can be any type of data repository, data storage, database, and/or cloud-based storage system. The data store 242 can maintain a variety of information about different physical components, bed systems, and/or users of bed systems. Additionally or alternatively, the data store 242 can maintain data such as test actions 244A-N, test instructions 246A-N, test execution results 248A-N, results output 250A-N, test execution evaluations 252A-N, physical component state data 264A-N, and/or physical component log files 266A-N.

In brief, the test actions 244A-N can include the user input received from the user devices 110A-N and at the computer system 102 indicating one or more actions or aspects (e.g., functional, visual) of the physical component 104 to be tested. The test instructions 246A-N can include testing instructions that are generated by the back-end system 200 based on the user input (e.g., the test actions 244A-N). The test execution results 248A-N can be part of the physical component state data 264A-N and/or the physical component log files 266A-N. The test execution results 248A-N can include data about aspects of the physical component 104 that are tested and assessed when the test instructions 246A-N are executed at the physical component 104. The results output 250A-N can include output generated by the output generator 204 of the back-end system 200, which can be based on at least the test execution results 248A-N. The test execution evaluations 252A-N can include one or more assessments and/or recommendations that are performed by the testing analysis engine 206 of the back-end system 200 to determine ways in which aspects (e.g., functional, visual) of the physical component 104 can be improved. The physical component state data 264A-N can include state data that is retrieved from the physical component 104 via the interface 108 before, during, and/or after execution of the test instructions 246A-N. Similarly, the physical component log files 266A-N can include logs that are generated by the physical component 104 before, during, and/or after execution of the test instructions 246A-N. The state data 264A-N and the log files 266A-N can be used by the output generator 204 to generate output about test execution for presentation to the user at the user device(s) 110. The state data 264A-N and the log files 266A-N can be used by the testing analysis engine 206 to assess results from testing the physical component 104 and/or generate one or more recommendations for improving aspects of the physical component 104.

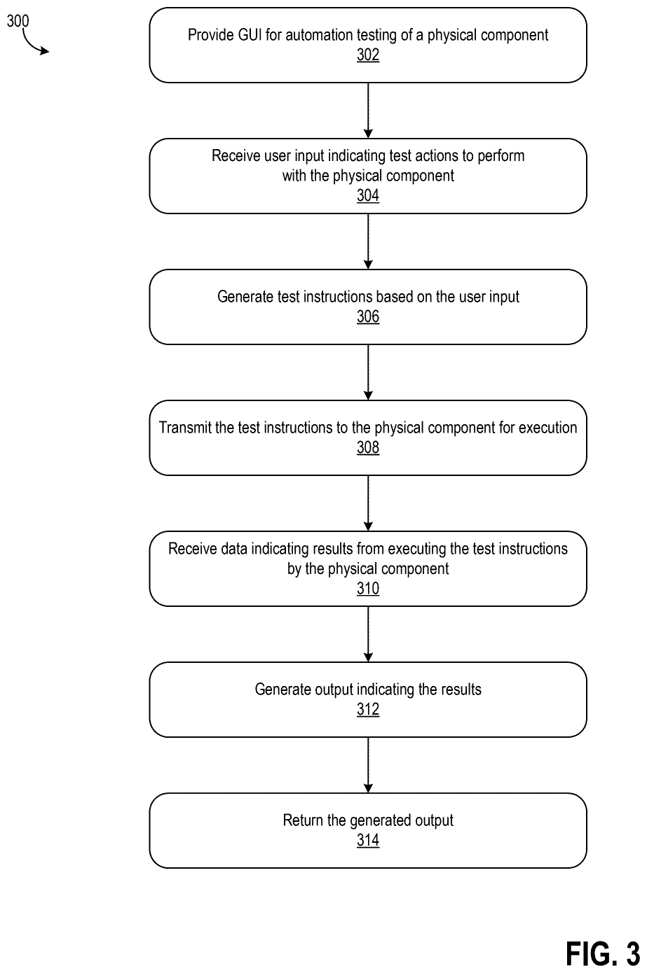

FIG. 3 is a flowchart of a process 300 for automation testing of a physical component, such as a smart bed system component. The process 300 can be performed by the computer system 102. One or more blocks in the process 300 can be performed by the back-end system 200. One or more blocks in the process 300 can be performed by the front-end system 208. The process 300 can be performed by one or more other servers, computer systems, computing devices, cloud-based system, and/or network of computing systems/devices. For illustrative purposes, the process 300 is described from the perspective of a computer system.

Referring to the process 300 in FIG. 3, the computer system can provide a GUI for automation testing of a physical component in block 302. The GUI can present a visual display of the physical component and user-interactable options that represent physical selectable controls on the physical component. For example, the physical component can be a smart bed system controller, such as a remote control. The GUI can present a visual representation of the remote control to a relevant user. The GUI can also present graphical elements such as buttons (e.g., controls) that correspond to different physical buttons or other controls on the remote control. The user can select one or more of the graphical elements to mimic or otherwise simulate what buttons or other physical controls on the remote the user desires to test. Refer to FIG. 1B for further discussion about the GUI.

In block 304, the computer system can receive user input indicating test actions to perform with the physical component. For example, the user can select one or more of the user-selectable options in the GUI to indicate what physical controls or other features (e.g., functional, visual) of the physical component that the user desires to test. As an illustrative example, the user can select a series of buttons in a particular order to be tested at the remote. As another example, the user can select options for adjusting how much power supply is provided to the remote and/or how the remote functions when supplied with a particular amount of power (e.g., less than a threshold amount of power, more than a threshold amount of power). As yet another example, the user can select options to view information that is presented in a user interface display of the remote in response to one or more actions being performed to adjust a smart bed with the remote (e.g., adjusting a pressure or firmness level in one or more air chambers of the smart bed, articulating one or more sides of a foundation of the smart bed, activating/deactivating one or more heater elements, fans, or other thermal modules at the smart bed).

Accordingly, the computer system can generate test instructions based on the user input in block 306.

The computer system can transmit the test instructions to the physical component for execution (block 308). The physical component can, for example, automatically execute the test instructions. In some implementations, the computer system can cause the test instructions to be executed at the physical component.

The computer system can receive data indicating results from executing the test instructions by the physical component (block 310). The results can include functional results based on executing the test instructions to test functionality of physical selectable controls on the physical component. The results can additionally or alternatively include visual results from executing the test instructions to test visual output presented at a user interface display of the physical component in response to executing the test instructions.

As described in reference to at least FIG. 2, the data can include state data and/or log files that are generated by the physical component and retrieved using an interface providing a physical connection between the computer system and the physical component. The data can be received before, during, and/or after execution of the test instructions.

As an illustrative example of block 310, the computer system can include a logging software subsystem that can be configured to communicate with the physical component via the interface, retrieve, from the physical component, logs resulting from testing the physical component according to the one or more test actions, and attach the retrieved logs to test run data that correspond to each of the one or more test actions. Sometimes, the logging software subsystem can also store the test run data with the attached logs in a data store for subsequent test evaluation of the physical component.

The computer system can generate output indicating the results in block 312. In some implementations, block 312 can include assessing the data received in block 310 and determining one or more recommendations for improving functional and/or visual aspects of the physical component. The recommendations can then be provided as part of the output. In some implementations, block 312 can be performed in real-time and based on the received data. Real-time performance can include receiving the results data and generating the output without noticeable time delay. Real-time performance can include processing the received data without intentional time delay. In some implementations, block 312 can be performed in near real-time. Near real-time performance can include receiving the results data and generating the output with some time delay, which may be an intentional or unintentional time delay.

In block 314, the computer system returns the generated output. Returning the output can include storing the output in a data store, as described herein. Returning the output can include providing the output to the user device for presentation in the GUI to the relevant user at the user device. The user can then review the output and make one or more determinations about whether and how they can improve aspects of the physical component (e.g., functional aspects of controls or buttons on the remote, visual aspects of information displayed in the user interface display of the remote).

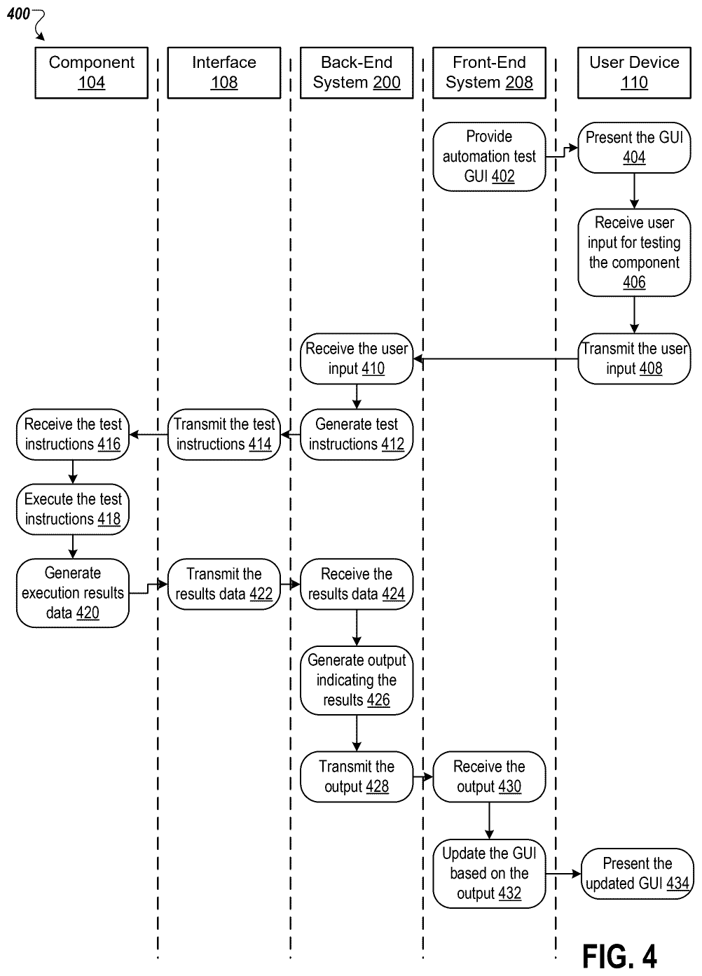

FIG. 4 is a swimlane diagram of a process 400 for automation testing of a physical component, such as a smart bed system component. The process 400 can be performed by various components described herein, such as the physical component 104, the interface 108, the back-end system 200, the front-end system 208, and the user device 110. Refer to FIGS. 1-2 for further discussion about these components.

The process 400 can also be performed by one or more other servers, computer systems, computing devices, cloud-based system, network of computing systems/devices, and/or physical components.

Referring to the process 400 in FIG. 4, the front-end system 208 can provide an automation testing framework to the user device 110 in block 402. For example, the front-end system 208 can provide a GUI for receiving user input indicating one or more test actions to perform with the physical component 104, which can be a smart bed remote control. The test actions can include simulation of pressing one or more buttons on the smart bed remote control.

In block 404, the user device 110 can present the GUI in a user interface display of the user device 110, as described throughout this disclosure. The GUI can present a visual display of the physical component 104 and user-interactable options that represent physical selectable controls on the physical component 104. The GUI can be a web interface to be launched in a web application at the user device 110. The user device 110 can be remote or separate from the physical component 104 being tested.

The user device 110 can receive user input for testing the physical component 104 (block 406). As described herein, the user input can include one or more test actions to be performed, such as selection of one or more physical controls on the physical component 104.

The user device 110 can transmit the user input to the back-end system 200 (block 408). As described herein, the back-end system 200 can provide communication between the front-end system 208 and the physical component 104 via the interface 108.

The back-end system 200 can receive the user input (block 410) and generate test instructions based on the user input (block 412). For example, the back-end system 200 can receive, from the front-end system 208, the user input indicating the one or more test actions to perform with the physical component 104.

The back-end system 200 can transmit the test instruction to the physical component 104 via the interface 108 in block 414. The physical component 104 may receive the test instructions in block 416 and execute the test instructions in block 418. In some implementations, transmitting the test instructions causes the one or more test actions in the test instructions to be executed by the physical component 104.

Based on executing the test instructions, the physical component 104 can generate execution results data (block 420). The physical component 104 may transmit the results data in block 422 to the back-end system 200 via the interface 108. The results can include functional results based on executing the test instructions to test functionality of the physical selectable controls on physical component 104. The results can additionally or alternatively include visual results from executing the test instructions to test visual output presented at a user interface display of the physical component 104 in response to executing the test instructions.

Once the back-end system 200 receives the results data (block 424), the back-end system 200 can generate output indicating the results in block 426. The output can be generated in real-time. The output can be generated in near real-time.

The back-end system 200 can transmit the output to the front-end system 208 (block 428), which receives the output (block 430).

Based on the output, the front-end system 208 updates the GUI (block 432) and transmits the updated GUI to the user device 110. The user device 110 then presents the updated GUI in the user interface display of the user device 110 (block 434).

In some implementations, the user device 110 can receive subsequent user input indicating one or more test actions to perform at the physical component 104. The subsequent user input may additionally or alternatively indicate one or more modifications that the user would like to make to the physical component 104. The subsequent user input can be based on the results from the test instruction execution, which are presented in the updated GUI at the user device 110.

### Example Airbed Hardware

FIG. 5 shows an example air bed system 500 that includes a bed 512. The bed system 500 can be the same as or similar to the bed system 101 described in reference to at least FIG. 1A. The bed 512 can be a mattress that includes at least one air chamber 514 surrounded by a resilient border 516 and encapsulated by bed ticking 518. The resilient border 516 can comprise any suitable material, such as foam. In some embodiments, the resilient border 516 can combine with a top layer or layers of foam (not shown in FIG. 5) to form an upside down foam tub. In other embodiments, mattress structure can be varied as suitable for the application.

As illustrated in FIG. 5, the bed 512 can be a two chamber design having first and second fluid chambers, such as a first air chamber 514A and a second air chamber 514B. Sometimes, the bed 512 can include chambers for use with fluids other than air that are suitable for the application. For example, the fluids can include liquid. In some embodiments, such as single beds or kids' beds, the bed 512 can include a single air chamber 514A or 514B or multiple air chambers 514A and 514B. Although not depicted, sometimes, the bed 512 can include additional air chambers.

The first and second air chambers 514A and 514B can be in fluid communication with a pump 520. The pump 520 can be in electrical communication with a remote control 522 via control box 524. The control box 524 can include a wired or wireless communications interface for communicating with one or more devices, including the remote control 522. The control box 524 can be configured to operate the pump 520 to cause increases and decreases in the fluid pressure of the first and second air chambers 514A and 514B based upon commands input by a user using the remote control 522. In some implementations, the control box 524 is integrated into a housing of the pump 520. Moreover, sometimes, the pump 520 can be in wireless communication (e.g., via a home network, WIFI, BLUETOOTH, or other wireless network) with a mobile device via the control box 524. The mobile device can include but is not limited to the user's smartphone, cell phone, laptop, tablet, computer, wearable device, home automation device, or other computing device. A mobile application can be presented at the mobile device and provide functionality for the user to control the bed 512 and view information about the bed 512. The user can input commands in the mobile application presented at the mobile device. The inputted commands can be transmitted to the control box 524, which can operate the pump 520 based upon the commands.

The remote control 522 can include a display 526, an output selecting mechanism 528, a pressure increase button 529, and a pressure decrease button 530. The remote control 522 can include one or more additional output selecting mechanisms and/or buttons. The display 526 can present information to the user about settings of the bed 512. For example, the display 526 can present pressure settings of both the first and second air chambers 514A and 514B or one of the first and second air chambers 514A and 514B. Sometimes, the display 526 can be a touch screen, and can receive input from the user indicating one or more commands to control pressure in the first and second air chambers 514A and 514B and/or other settings of the bed 512.

The output selecting mechanism 528 can allow the user to switch air flow generated by the pump 520 between the first and second air chambers 514A and 514B, thus enabling control of multiple air chambers with a single remote control 522 and a single pump 520. For example, the output selecting mechanism 528 can by a physical control (e.g., switch or button) or an input control presented on the display 526. Alternatively, separate remote control units can be provided for each air chamber 514A and 514B and can each include the ability to control multiple air chambers. Pressure increase and decrease buttons 529 and 530 can allow the user to increase or decrease the pressure, respectively, in the air chamber selected with the output selecting mechanism 528. Adjusting the pressure within the selected air chamber can cause a corresponding adjustment to the firmness of the respective air chamber. In some embodiments, the remote control 522 can be omitted or modified as appropriate for an application.

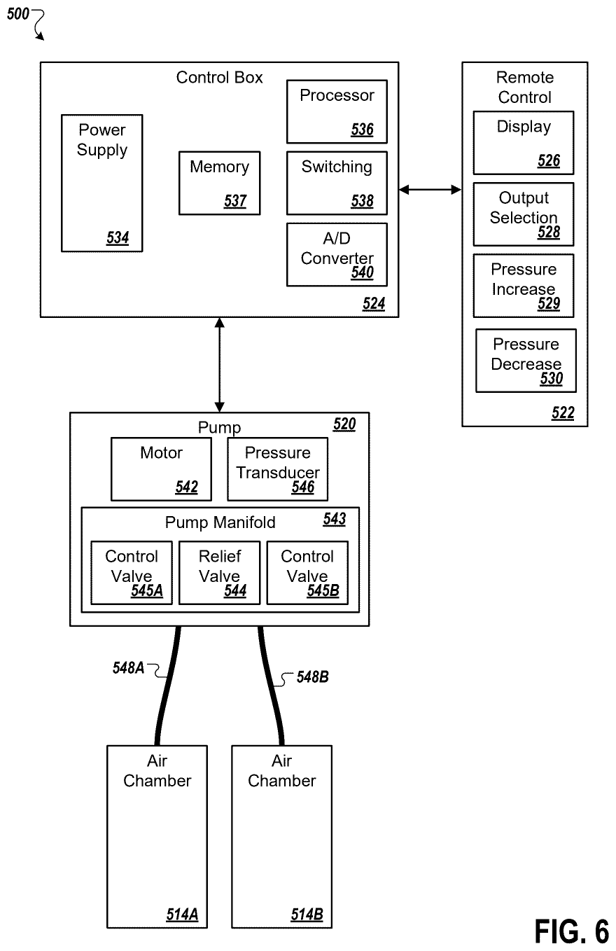

FIG. 6 is a block diagram of an example of various components of an air bed system, such as the air bed system of FIG. 5. These components can be used in the example air bed system 500. The control box 524 can include a power supply 534, a processor 536, a memory 537, a switching mechanism 538, and an analog to digital (A/D) converter 540. The switching mechanism 538 can be, for example, a relay or a solid state switch. In some implementations, the switching mechanism 538 can be located in the pump 520 rather than the control box 524. The pump 520 and the remote control 522 can be in two-way communication with the control box 524. The pump 520 includes a motor 542, a pump manifold 543, a relief valve 544, a first control valve 545A, a second control valve 545B, and a pressure transducer 546. The pump 520 is fluidly connected with the first air chamber 514A and the second air chamber 514B via a first tube 548A and a second tube 548B, respectively. The first and second control valves 545A and 545B can be controlled by switching mechanism 538, and are operable to regulate the flow of fluid between the pump 520 and first and second air chambers 514A and 514B, respectively.

In some implementations, the pump 520 and the control box 524 can be provided and packaged as a single unit. In some implementations, the pump 520 and the control box 524 can be provided as physically separate units. The control box 524, the pump 520, or both can be integrated within or otherwise contained within a bed frame, foundation, or bed support structure that supports the bed 512. Sometimes, the control box 524, the pump 520, or both can be located outside of a bed frame, foundation, or bed support structure (as shown in the example in FIG. 5).

The air bed system 500 in FIG. 2 includes the two air chambers 514A and 514B and the single pump 520 of the bed 512 depicted in FIG. 5. However, other implementations can include an air bed system having two or more air chambers and one or more pumps incorporated into the air bed system to control the air chambers. For example, a separate pump can be associated with each air chamber. As another example, a pump can be associated with multiple chambers. A first pump can be associated with air chambers that extend longitudinally from a left side to a midpoint of the air bed system 500 and a second pump can be associated with air chambers that extend longitudinally from a right side to the midpoint of the air bed system 500. Separate pumps can allow each air chamber to be inflated or deflated independently and/or simultaneously. Additional pressure transducers can also be incorporated into the air bed system 500 such that a separate pressure transducer can be associated with each air chamber.

As an illustrative example, in use, the processor 536 can send a decrease pressure command to one of air chambers 514A or 514B, and the switching mechanism 538 can convert the low voltage command signals sent by the processor 536 to higher operating voltages sufficient to operate the relief valve 544 of the pump 520 and open the respective control valve 545A or 545B. Opening the relief valve 544 can allow air to escape from the air chamber 514A or 514B through the respective air tube 548A or 548B. During deflation, the pressure transducer 546 can send pressure readings to the processor 536 via the A/D converter 540. The A/D converter 540 can receive analog information from pressure transducer 546 and can convert the analog information to digital information useable by the processor 536. The processor 536 can send the digital signal to the remote control 522 to update the display 526 to convey the pressure information to the user. The processor 536 can also send the digital signal to other devices in wired or wireless communication with the air bed system, including but not limited to mobile devices described herein. The user can then view pressure information associated with the air bed system at their device instead of at, or in addition to, the remote control 522.

As another example, the processor 536 can send an increase pressure command. The pump motor 542 can be energized in response to the increase pressure command and send air to the designated one of the air chambers 514A or 514B through the air tube 548A or 548B via electronically operating the corresponding valve 545A or 545B. While air is being delivered to the designated air chamber 514A or 514B to increase the chamber firmness, the pressure transducer 546 can sense pressure within the pump manifold 543. The pressure transducer 546 can send pressure readings to the processor 536 via the A/D converter 540. The processor 536 can use the information received from the A/D converter 540 to determine the difference between the actual pressure in air chamber 514A or 514B and the desired pressure. The processor 536 can send the digital signal to the remote control 522 to update display 526.

Generally speaking, during an inflation or deflation process, the pressure sensed within the pump manifold 543 can provide an approximation of the actual pressure within the respective air chamber that is in fluid communication with the pump manifold 543. An example method includes turning off the pump 520, allowing the pressure within the air chamber 514A or 514B and the pump manifold 543 to equalize, then sensing the pressure within the pump manifold 543 with the pressure transducer 546. Providing a sufficient amount of time to allow the pressures within the pump manifold 543 and chamber 514A or 514B to equalize can result in pressure readings that are accurate approximations of actual pressure within air chamber 514A or 514B. In some implementations, the pressure of the air chambers 514A and/or 514B can be continuously monitored using multiple pressure sensors (not shown). The pressure sensors can be positioned within the air chambers. The pressure sensors can also be fluidly connected to the air chambers, such as along the air tubes 548A and 548B.

In some implementations, information collected by the pressure transducer 546 can be analyzed to determine various states of a user laying on the bed 512. For example, the processor 536 can use information collected by the pressure transducer 546 to determine a heartrate or a respiration rate for the user. As an illustrative example, the user can be laying on a side of the bed 512 that includes the chamber 514A. The pressure transducer 546 can monitor fluctuations in pressure of the chamber 514A, and this information can be used to determine the user's heartrate and/or respiration rate. As another example, additional processing can be performed using the collected data to determine a sleep state of the user (e.g., awake, light sleep, deep sleep). For example, the processor 536 can determine when the user falls asleep and, while asleep, the various sleep states (e.g., sleep stages) of the user. Based on the determined heartrate, respiration rate, and/or sleep states of the user, the processor 536 can determine information about the user's sleep quality. The processor 536 can, for example, determine how well the user slept during a particular sleep cycle. The processor 536 can also determine user sleep cycle trends. Accordingly, the processor 536 can generate recommendations to improve the user's sleep quality and overall sleep cycle. Information that is determined about the user's sleep cycle (e.g., heartrate, respiration rate, sleep states, sleep quality, recommendations to improve sleep quality, etc.) can be transmitted to the user's mobile device and presented in a mobile application, as described above.

Additional information associated with the user of the air bed system 500 that can be determined using information collected by the pressure transducer 546 includes user motion, presence on a surface of the bed 512, weight, heart arrhythmia, snoring, partner snore, and apnea. One or more other health conditions of the user can also be determined based on the information collected by the pressure transducer 546. Taking user presence detection for example, the pressure transducer 546 can be used to detect the user's presence on the bed 512, e.g., via a gross pressure change determination and/or via one or more of a respiration rate signal, heartrate signal, and/or other biometric signals. Detection of the user's presence can be beneficial to determine, by the processor 536, adjustment(s) to make to settings of the bed 512 (e.g., adjusting a firmness when the user is present to a user-preferred firmness setting) and/or peripheral devices (e.g., turning off lights when the user is present, activating a heating or cooling system, etc.).

For example, a simple pressure detection process can identify an increase in pressure as an indication that the user is present. As another example, the processor 536 can determine that the user is present if the detected pressure increases above a specified threshold (so as to indicate that a person or other object above a certain weight is positioned on the bed 512). As yet another example, the processor 536 can identify an increase in pressure in combination with detected slight, rhythmic fluctuations in pressure as corresponding to the user being present. The presence of rhythmic fluctuations can be identified as being caused by respiration or heart rhythm (or both) of the user. The detection of respiration or a heartbeat can distinguish between the user being present on the bed and another object (e.g., a suitcase, a pet, a pillow, etc.) being placed thereon.

In some implementations, pressure fluctuations can be measured at the pump 520. For example, one or more pressure sensors can be located within one or more internal cavities of the pump 520 to detect pressure fluctuations within the pump 520. The fluctuations detected at the pump 520 can indicate pressure fluctuations in the chambers 514A and/or 514B. One or more sensors located at the pump 520 can be in fluid communication with the chambers 514A and/or 514B, and the sensors can be operative to determine pressure within the chambers 514A and/or 514B. The control box 524 can be configured to determine at least one vital sign (e.g., heartrate, respiratory rate) based on the pressure within the chamber 514A or the chamber 514B.

The control box 524 can also analyze a pressure signal detected by one or more pressure sensors to determine a heartrate, respiration rate, and/or other vital signs of the user lying or sitting on the chamber 514A and/or 514B. More specifically, when a user lies on the bed 512 and is positioned over the chamber 514A, each of the user's heart beats, breaths, and other movements (e.g., hand, arm, leg, foot, or other gross body movements) can create a force on the bed 512 that is transmitted to the chamber 514A. As a result of this force input, a wave can propagate through the chamber 514A and into the pump 520. A pressure sensor located at the pump 520 can detect the wave, and thus the pressure signal outputted by the sensor can indicate a heartrate, respiratory rate, or other information regarding the user.

With regard to sleep state, the air bed system 500 can determine the user's sleep state by using various biometric signals such as heartrate, respiration, and/or movement of the user. While the user is sleeping, the processor 536 can receive one or more of the user's biometric signals (e.g., heartrate, respiration, motion, etc.) and can determine the user's present sleep state based on the received biometric signals. In some implementations, signals indicating fluctuations in pressure in one or both of the chambers 514A and 514B can be amplified and/or filtered to allow for more precise detection of heartrate and respiratory rate.

Sometimes, the processor 536 can receive additional biometric signals of the user from one or more other sensors or sensor arrays positioned on or otherwise integrated into the air bed system 500. For example, one or more sensors can be attached or removably attached to a top surface of the air bed system 500 and configured to detect signals such as heartrate, respiration rate, and/or motion. The processor 536 can combine biometric signals received from pressure sensors located at the pump 520, the pressure transducer 546, and/or the sensors positioned throughout the air bed system 500 to generate accurate and more precise information about the user and their sleep quality.

Sometimes, the control box 524 can perform a pattern recognition algorithm or other calculation based on the amplified and filtered pressure signal(s) to determine the user's heartrate and/or respiratory rate. For example, the algorithm or calculation can be based on assumptions that a heartrate portion of the signal has a frequency in a range of 0.5-4.0 Hz and that a respiration rate portion of the signal has a frequency in a range of less than 1 Hz. Sometimes, the control box 524 can use one or more machine learning models to determine the user's health information. The models can be trained using training data that includes training pressure signals and expected heartrates and/or respiratory rates. Sometimes, the control box 524 can determine user health information by using a lookup table that corresponds to sensed pressure signals.

The control box 524 can also be configured to determine other characteristics of the user based on the received pressure signal, such as blood pressure, tossing and turning movements, rolling movements, limb movements, weight, presence or lack of presence of the user, and/or the identity of the user.

For example, the pressure transducer 546 can be used to monitor the air pressure in the chambers 514A and 514B of the bed 512. If the user on the bed 512 is not moving, the air pressure changes in the air chamber 514A or 514B can be relatively minimal, and can be attributable to respiration and/or heartbeat. When the user on the bed 512 is moving, however, the air pressure in the mattress can fluctuate by a much larger amount. The pressure signals generated by the pressure transducer 546 and received by the processor 536 can be filtered and indicated as corresponding to motion, heartbeat, or respiration. The processor 536 can attribute such fluctuations in air pressure to the user's sleep quality. Such attributions can be determined based on applying one or more machine learning models and/or algorithms to the pressure signals. For example, if the user shifts and turns a lot during a sleep cycle (for example, in comparison to historic trends of the user's sleep cycles), the processor 536 can determine that the user experienced poor sleep during that particular sleep cycle.

In some implementations, rather than performing the data analysis in the control box 524 with the processor 536, a digital signal processor (DSP) can be provided to analyze the data collected by the pressure transducer 546. Alternatively, the collected data can be sent to a cloud-based computing system for remote analysis.

In some implementations, the example air bed system 500 further includes a temperature controller configured to increase, decrease, or maintain a temperature of the bed 512, for example for the comfort of the user. For example, a pad (e.g., mat, layer, etc.) can be placed on top of or be part of the bed 512, or can be placed on top of or be part of one or both of the chambers 514A and 514B. Air can be pushed through the pad and vented to cool off the user on the bed 512. Additionally or alternatively, the pad can include a heating element used to keep the user warm. In some implementations, the temperature controller can receive temperature readings from the pad. The temperature controller can determine whether the temperature readings are less than or greater than some threshold range and/or value. Based on this determination, the temperature controller can actuate components to push air through the pad to cool off the user or active the heating element. In some implementations, separate pads are used for different sides of the bed 512 (e.g., corresponding to the locations of the chambers 514A and 514B) to provide for differing temperature control for the different sides of the bed 512. Each pad can be selectively controlled by the temperature controller to provide cooling or heating preferred by each user on the different sides of the bed 512. For example, a first user on a left side of the bed 512 can prefer to have their side of the bed 512 cooled during the night while a second user on a right side of the bed 512 can prefer to have their side of the bed 512 warmed during the night.

In some implementations, the user of the air bed system 500 can use an input device, such as the remote control 522 or a mobile device as described above, to input a desired temperature for a surface of the bed 512 (or for a portion of the surface of the bed 512, for example at a foot region, a lumbar or waist region, a shoulder region, and/or a head region of the bed 512). The desired temperature can be encapsulated in a command data structure that includes the desired temperature and also identifies the temperature controller as the desired component to be controlled. The command data structure can then be transmitted via Bluetooth or another suitable communication protocol (e.g., WIFI, a local network, etc.) to the processor 536. In various examples, the command data structure is encrypted before being transmitted. The temperature controller can then configure its elements to increase or decrease the temperature of the pad depending on the temperature input provided at the remote control 522 by the user.

In some implementations, data can be transmitted from a component back to the processor 536 or to one or more display devices, such as the display 526 of the remote controller 522. For example, the current temperature as determined by a sensor element of a temperature controller, the pressure of the bed, the current position of the foundation or other information can be transmitted to control box 524. The control box 524 can transmit this information to the remote control 522 to be displayed to the user (e.g., on the display 526). As described above, the control box 524 can also transmit the received information to a mobile device to be displayed in a mobile application or other graphical user interface (GUI) to the user.

In some implementations, the example air bed system 500 further includes an adjustable foundation and an articulation controller configured to adjust the position of the bed 512 by adjusting the adjustable foundation supporting the bed. For example, the articulation controller can adjust the bed 512 from a flat position to a position in which a head portion of a mattress of the bed is inclined upward (e.g., to facilitate a user sitting up in bed and/or watching television). The bed 512 can also include multiple separately articulable sections. As an illustrative example, the bed 512 can include one or more of a head portion, a lumbar/waist portion, a leg portion, and/or a foot portion, all of which can be separately articulable. As another example, portions of the bed 512 corresponding to the locations of the chambers 514A and 514B can be articulated independently from each other, to allow one user positioned on the bed 512 surface to rest in a first position (e.g., a flat position or other desired position) while a second user rests in a second position (e.g., a reclining position with the head raised at an angle from the waist or another desired position). Separate positions can also be set for two different beds (e.g., two twin beds placed next to each other). The foundation of the bed 512 can include more than one zone that can be independently adjusted.

Sometimes, the bed 512 can be adjusted to one or more user-defined positions based on user input and/or user preferences. For example, the bed 512 can automatically adjust, by the articulation controller, to one or more user-defined settings. As another example, the user can control the articulation controller to adjust the bed 512 to one or more user-defined positions. Sometimes, the bed 512 can be adjusted to one or more positions that may provide the user with improved or otherwise improve sleep and sleep quality. For example, a head portion on one side of the bed 512 can be automatically articulated, by the articulation controller, when one or more sensors of the air bed system 500 detect that a user sleeping on that side of the bed 512 is snoring. As a result, the user's snoring can be mitigated so that the snoring does not wake up another user sleeping in the bed 512.

In some implementations, the bed 512 can be adjusted using one or more devices in communication with the articulation controller or instead of the articulation controller. For example, the user can change positions of one or more portions of the bed 512 using the remote control 522 described above. The user can also adjust the bed 512 using a mobile application or other graphical user interface presented at a mobile computing device of the user.

The articulation controller can also provide different levels of massage to one or more portions of the bed 512 for one or more users. The user(s) can adjust one or more massage settings for the portions of the bed 512 using the remote control 522 and/or a mobile device in communication with the air bed system 500.

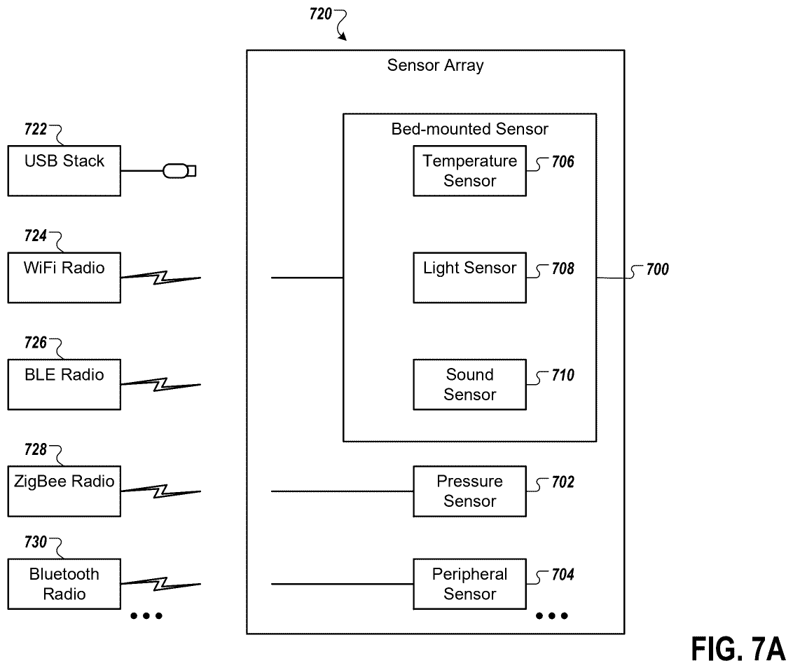

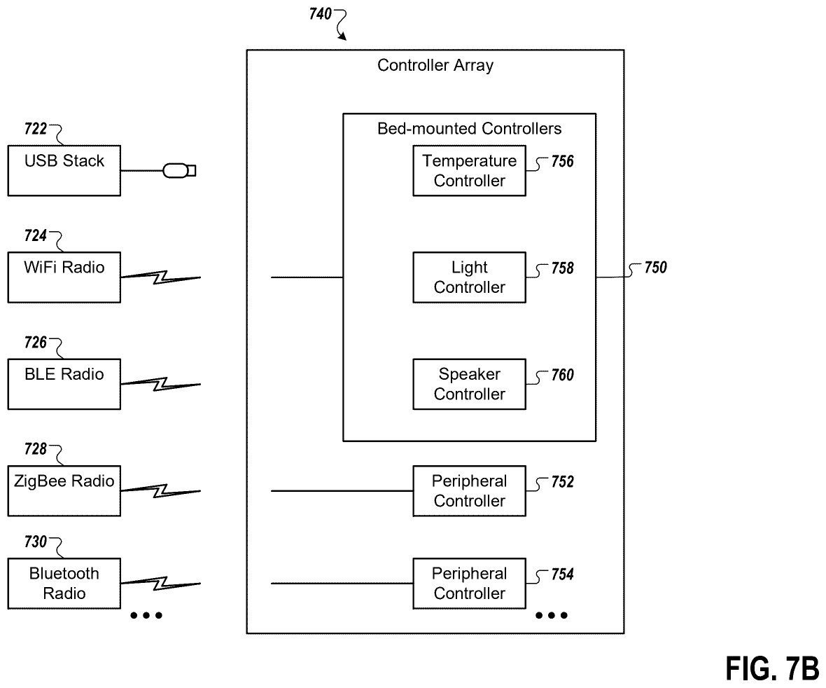

FIG. 7A is a block diagram of an example of a sensory array 720 that can be used in a data processing system associated with a bed. The sensor array 720 is a conceptual grouping of some or all peripheral sensors that communicate with the motherboard but are not native to the motherboard. The peripheral sensors 702, 704, 706, 708, 710, etc. of the sensor array 720 communicate with the motherboard through one or more network interfaces 722, 724, 726, 728, and/or 730 of the motherboard, as is appropriate for the configuration of the particular sensor. For example, a sensor that outputs a reading over a USB cable can communicate through USB stack 722.

Some peripheral sensors of the sensor array 720 can be bed mounted sensors 700 (e.g., temperature sensor 706, light sensor 708, sound sensor 710). The bed mounted sensors 700 can be embedded into a bed structure and sold with the bed, or later affixed to the structure (e.g., part of a pressure sensing pad that is removably installed on a top surface of the bed, part of a temperature sensing or heating pad that is removably installed on the top surface of the bed, integrated into the top surface, attached along connecting tubes between a pump and air chambers, within air chambers, attached to a headboard, attached to one or more regions of an adjustable foundation). One or more of the sensors 702 can be load cells or force sensors. Other sensors 702 and 704 may not be mounted to the bed and can include a pressure sensor 702 and/or peripheral sensor 704. For example, the sensors 702 and 704 can be integrated or otherwise part of a user mobile device (e.g., mobile phone, wearable device). The sensors 702 and 704 can also be part of a central controller for controlling the bed and peripheral devices. Sometimes, the sensors 702 and 704 can be part of one or more home automation devices or other peripheral devices. In some implementations, the peripheral sensors 704 can include but are not limited to light-detection-and-ranging (LiDAR), radar, and/or time-of-flight (ToF) sensors. LiDAR sensors can, for example emit light from a laser in order to collect measurements, including but not limited to user movement and/or user biometrics. The light can be emitted from pulsed laser beams with wavelengths in a near-infrared (NIR) range. Radar sensors can use radio waves and/or microwaves and thus operate at longer wavelengths than LiDAR sensors. Radar sensors can similarly be used to detect user movement and/or user biometrics. ToF sensors can be used to determine amounts of time that it takes photons or other energy particles to travel between two points, which can be similarly used to detect user movement and/or user biometrics. One or more other peripheral sensors 704 are also possible.

Sometimes, some or all of the bed mounted sensors 700 and/or sensors 702 and 704 share networking hardware (e.g., a conduit that contains wires from each sensor, a multi-wire cable or plug that, when affixed to the motherboard, connect all the associated sensors with the motherboard). One, some, or all the sensors 702, 704, 706, 708, and 710 can sense features of a mattress (e.g., pressure, temperature, light, sound, and/or other features) and features external to the mattress. Sometimes, pressure sensor 702 can sense pressure of the mattress while some or all the sensors 702, 704, 706, 708, and 710 sense features of the mattress and/or features external to the mattress.

FIG. 7B is a block diagram of an example of a control array 740 that can be used in a data processing system associated with a bed. The controller array 740 is a conceptual grouping of some or all peripheral controllers that communicate with the motherboard but are not native to the motherboard. The peripheral controllers can communicate with the motherboard through one or more of the network interfaces 722, 724, 726, 728 and/or 730 of the motherboard, as is appropriate for the configuration of the particular controller. Some of the controllers can be bed mounted controllers 750, such as a temperature controller 756, a light controller 758, and a speaker controller 760, as described in reference to bed-mounted sensors in FIG. 7A. Peripheral controllers 752 and 754 can be in communication with the motherboard, but optionally not mounted to the bed.

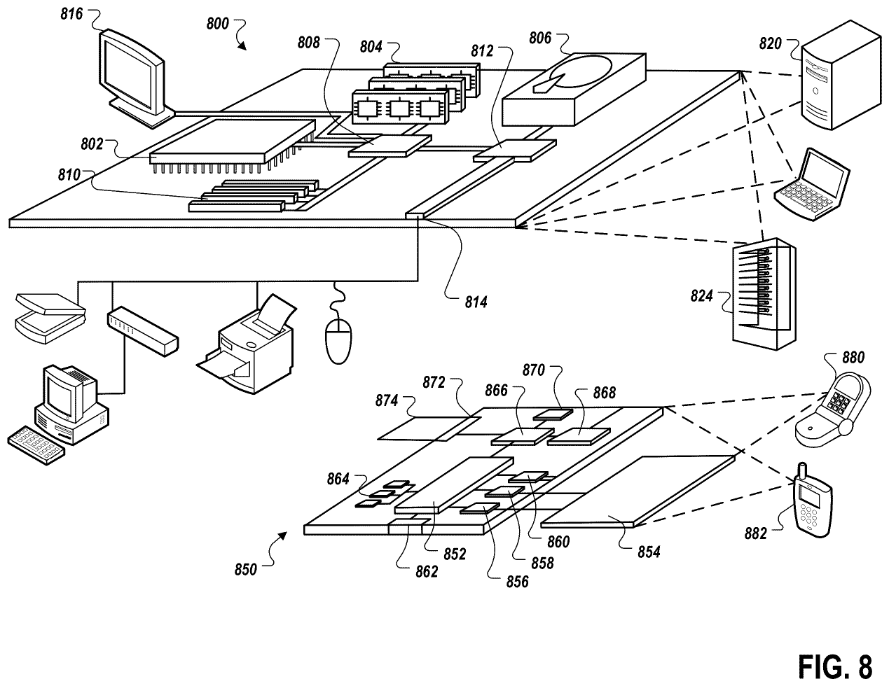

FIG. 8 shows an example of a computing device 800 and an example of a mobile computing device that can be used to implement the techniques described here. The computing device 800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and can be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 can also be another form of computer-readable medium, such as a magnetic or optical disk.

The storage device 806 is capable of providing mass storage for the computing device 800. In some implementations, the storage device 806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 804, the storage device 806, or memory on the processor 802.

The high-speed interface 808 manages bandwidth-intensive operations for the computing device 800, while the low-speed interface 812 manages lower bandwidth-intensive operations. Such allocation of functions is exemplary only. In some implementations, the high-speed interface 808 is coupled to the memory 804, the display 816 (e.g., through a graphics processor or accelerator), and to the high-speed expansion ports 810, which can accept various expansion cards (not shown). In the implementation, the low-speed interface 812 is coupled to the storage device 806 and the low-speed expansion port 814. The low-speed expansion port 814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 800 can be implemented in a number of different forms, as shown in the figure. For example, it can be implemented as a standard server 820, or multiple times in a group of such servers. In addition, it can be implemented in a personal computer such as a laptop computer 822. It can also be implemented as part of a rack server system 824. Alternatively, components from the computing device 800 can be combined with other components in a mobile device (not shown), such as a mobile computing device 850. Each of such devices can contain one or more of the computing device 800 and the mobile computing device 850, and an entire system can be made up of multiple computing devices communicating with each other.

The mobile computing device 850 includes a processor 852, a memory 864, an input/output device such as a display 854, a communication interface 866, and a transceiver 868, among other components. The mobile computing device 850 can also be provided with a storage device, such as a micro-drive or other device, to provide additional storage. Each of the processor 852, the memory 864, the display 854, the communication interface 866, and the transceiver 868, are interconnected using various buses, and several of the components can be mounted on a common motherboard or in other manners as appropriate.

The processor 852 can execute instructions within the mobile computing device 850, including instructions stored in the memory 864. The processor 852 can be implemented as a chipset of chips that include separate and multiple analog and digital processors. The processor 852 can provide, for example, for coordination of the other components of the mobile computing device 850, such as control of user interfaces, applications run by the mobile computing device 850, and wireless communication by the mobile computing device 850.

The processor 852 can communicate with a user through a control interface 858 and a display interface 856 coupled to the display 854. The display 854 can be, for example, a TFT (Thin-Film-Transistor Liquid Crystal Display) display or an OLED (Organic Light Emitting Diode) display, or other appropriate display technology. The display interface 856 can comprise appropriate circuitry for driving the display 854 to present graphical and other information to a user. The control interface 858 can receive commands from a user and convert them for submission to the processor 852. In addition, an external interface 862 can provide communication with the processor 852, so as to enable near area communication of the mobile computing device 850 with other devices. The external interface 862 can provide, for example, for wired communication in some implementations, or for wireless communication in other implementations, and multiple interfaces can also be used.

The memory 864 stores information within the mobile computing device 850. The memory 864 can be implemented as one or more of a computer-readable medium or media, a volatile memory unit or units, or a non-volatile memory unit or units. An expansion memory 874 can also be provided and connected to the mobile computing device 850 through an expansion interface 872, which can include, for example, a SIMM (Single In Line Memory Module) card interface. The expansion memory 874 can provide extra storage space for the mobile computing device 850, or can also store applications or other information for the mobile computing device 850. Specifically, the expansion memory 874 can include instructions to carry out or supplement the processes described above, and can include secure information also. Thus, for example, the expansion memory 874 can be provide as a security module for the mobile computing device 850, and can be programmed with instructions that permit secure use of the mobile computing device 850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 864, the expansion memory 874, or memory on the processor 852. In some implementations, the computer program product can be received in a propagated signal, for example, over the transceiver 868 or the external interface 862.

The mobile computing device 850 can communicate wirelessly through the communication interface 866, which can include digital signal processing circuitry where necessary. The communication interface 866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 868 using a radio-frequency. In addition, short-range communication can occur, such as using a Bluetooth, WiFi, or other such transceiver (not shown). In addition, a GPS (Global Positioning System) receiver module 870 can provide additional navigation- and location-related wireless data to the mobile computing device 850, which can be used as appropriate by applications running on the mobile computing device 850.

The mobile computing device 850 can also communicate audibly using an audio codec 860, which can receive spoken information from a user and convert it to usable digital information. The audio codec 860 can likewise generate audible sound for a user, such as through a speaker, e.g., in a handset of the mobile computing device 850. Such sound can include sound from voice telephone calls, can include recorded sound (e.g., voice messages, music files, etc.) and can also include sound generated by applications operating on the mobile computing device 850.

The mobile computing device 850 can be implemented in a number of different forms, as shown in the figure. For example, it can be implemented as a cellular telephone 880. It can also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A testing device for a smart bed remote control, the testing device comprising:
an wired-data interface for communicating with a smart bed remote control over a wired-data network connection;
one or more processors; and
memory storing instructions that, when executed by the testing device, cause the testing device to perform operations comprising:
providing a graphical user interface (GUI) for receiving user input indicating one or more test actions to perform with the smart bed remote control, wherein the GUI presents a visual display of the smart bed remote control and user-interactable options that represent physical selectable controls on the smart bed remote control; and
receiving the user input indicating the one or more test actions to perform with the smart bed remote control;
generating, based on the user input, test instructions for the smart bed remote control;
transmitting, via the wired-data interface, the test instructions to the smart bed remote control, wherein transmitting the test instructions causes the one or more test actions to be executed by the smart bed remote control;
receiving, via the wired-data interface, data indicating results from executing the test instructions by the smart bed remote control, wherein the results include at least one of (i) functional results based on executing the test instructions to test functionality of the physical selectable controls on the smart bed remote control or (ii) visual results from executing the test instructions to test visual output presented at a user interface display of the smart bed remote control in response to executing the test instructions;
generating, based on the received data, output indicating the results; and
rendering the generated output for presentation in the GUI.

2. The testing device of claim 1, wherein the wired-data network connection comprises a debug probe and a serial adapter.

3. The testing device of claim 2, wherein the debug probe is configured to provide (i) direct memory access, (ii) framebuffer dumps, and (iii) retrieval of on-screen images of the visual output presented at the user interface display of the smart bed remote control between the smart bed remote control and the testing device.

4. The testing device of claim 2, wherein the operations further comprise transmitting firmware updates to the smart bed remote control using the debug probe of the interface to cause firmware of the smart bed remote control to be automatically updated according to the firmware updates.

5. The testing device of claim 2, wherein the serial adapter is configured to enable access to a serial console of the smart bed remote control by the testing device to (i) retrieve bed system component state data and (ii) pass tokens for simulating the one or more test actions.

6. The testing device of claim 1, wherein the one or more test actions include simulation of pressing one or more buttons on the smart bed remote control.

7. The testing device of claim 1, wherein the GUI is a web interface that is configured to be launched in a web application at a user computing device, the user computing device being configured to receive the user input indicating the one or more test actions to perform with the smart bed remote control.

8. The testing device of claim 1, wherein the wired-data interface is configured to provide power to the smart bed remote control.

9. The testing device of claim 1, wherein the operations further comprise testing of power capabilities of the smart bed remote control based on providing power to the smart bed remote control via the wired-data interface.

10. The testing device of claim 1, wherein the operations further comprise transmitting the GUI for presentation at a user computing device that is remote from the smart bed remote control.

11. The testing device of claim 1, further comprising a data store configured to store at least one of: the one or more test actions, the test instructions, the data indicating results from executing the test instructions, or the output indicating the results.

12. The testing device of claim 1, wherein the operations further comprise:
retrieving, from the smart bed remote control, logs resulting from testing the smart bed remote control according to the one or more test actions;
attach the retrieved logs to test run data that correspond to each of the one or more test actions; and
store the test run data with the attached logs in for subsequent test evaluation of the smart bed remote control.

13. The testing device of claim 1, wherein the smart bed remote control is configured to provide state information, via the wired-data interface, during execution of the one or more test actions, wherein the testing device is further configured to generate the output indicating the results based on the state information.

14. A method for automation testing of a bed system component, the method comprising:
receiving, by a back-end system from a front-end system, user input indicating one or more test actions to perform with a bed system component, wherein the back-end system is configured to provide communication between the front-end system and the bed system component via an interface, wherein the front-end system is configured to provide a graphical user interface (GUI) for receiving the user input indicating the one or more test actions to perform with the bed system component, wherein the GUI presents a visual display of the bed system component and user-interactable options that represent physical selectable controls on the bed system component;
generating, by the back-end system and based on the user input, test instructions for the bed system component;
transmitting, by the back-end system via the interface, the test instructions to the bed system component, wherein transmitting the test instructions causes the one or more test actions to be executed by the bed system component;
receiving, by the back-end system via the interface from the bed system component, data indicating results from executing the test instructions by the bed system component, wherein the results include at least one of (i) functional results based on executing the test instructions to test functionality of the physical selectable controls on the bed system component or (ii) visual results from executing the test instructions to test visual output presented at a user interface display of the bed system component in response to executing the test instructions;
generating, by the back-end system based on the received data, output indicating the results; and
transmitting, by the back-end system to the front-end system, the generated output for presentation in the GUI.

15. A system for testing a smart bed remote control, the system comprising:
an interface for communicating with a smart bed remote control;
a front-end system configured to provide a graphical user interface (GUI) for receiving user input indicating one or more test actions to perform with the smart bed remote control, wherein the GUI presents a visual display of the smart bed remote control and user-interactable options that represent physical selectable controls on the smart bed remote control; and
a back-end system configured to provide communication between the front-end system and the smart bed remote control via the interface, wherein the back-end system is further configured to:
receive, from the front-end system, the user input indicating the one or more test actions to perform with the smart bed remote control;
generate, based on the user input, test instructions for the smart bed remote control;
transmit, via the interface, the test instructions to the smart bed remote control, wherein transmitting the test instructions causes the one or more test actions to be executed by the smart bed remote control;
receive, via the interface, data indicating results from executing the test instructions by the smart bed remote control, wherein the results include at least one of (i) functional results based on executing the test instructions to test functionality of the physical selectable controls on the smart bed remote control or (ii) visual results from executing the test instructions to test visual output presented at a user interface display of the smart bed remote control in response to executing the test instructions;
generate, in real-time and based on the received data, output indicating the results; and
return, to the front-end system, the generated output for presentation in the GUI.

16. The system of claim 15, wherein the interface comprises a wired data port and a wired power port.

17. The system of claim 15, wherein the interface comprises a debug probe and a serial adapter.

18. The system of claim 17, wherein the debug probe is configured to provide direct access to memory registers.

19. The system of claim 15, wherein the interface comprises a single cable containing components for transmitting both data and power.

20. The system of claim 15, the system further comprising an battery internal to a housing containing at least some other components of the system.
